(19) United States
(12) Patent Application Publication
(10) Pub. No.: US 2008/0044314 A1
(43) Pub. Date: Feb. 21, 2008

(54) Pharmaceutical measuring and dispensing cup

(75) Inventors: Bradley T. McIntyre, Thorndale, PA (US); Piyush R. Patel, Wallingford, PA (US)

Correspondence Address: CEPHALON, INC., 41 MOORES ROAD, PO BOX 4011, FRAZER, PA, 19355, US

(73) Assignee: Cephalon, Inc., Frazer, PA (US)

(21) Appl. No.: 11/820,821

(22) Filed: Jun. 21, 2007

Related U.S. Application Data
(60) Provisional application No. 60/816,014, filed on Jun. 23, 2006.

(51) Int. Cl. B01L 3/02; G01F 11/26

(52) U.S. Cl. 422/102; 222/454

(57) ABSTRACT

A measuring and diluting cup for preparing pharmaceutical doses is provided. The cup comprises an upstanding body having an open mouth and a hollow interior bounded by a sidewall. The cup also has a pharmaceutical measuring compartment. The pharmaceutical measuring compartment is opposite the open mouth and forms a bottom of the hollow interior. The cup also has a diluent measuring compartment which is adjacent the open mouth. The pharmaceutical measuring compartment captures a measured volume smaller than the volume of the diluent measuring compartment, and the pharmaceutical measuring compartment opens to the diluent measuring compartment. The upstanding body is substantially cylindrical and the pharmaceutical measuring compartment has a cylindrical or conical region concentric with the upstanding body. The pharmaceutical measuring compartment has a smaller diameter than the upstanding body.

### FIELD OF THE INVENTION

The invention relates to measuring cups, and pharmaceutical measuring and diluting cups in particular.

### BACKGROUND OF THE INVENTION

Inaccurate medication dosing is too common and costly. Medical literature abounds with statistics and objective data supporting the finding that inaccurate medication dosing in the pediatric patient population is a common problem. For example, a significant number of patients are hospitalized with medication dosing errors, die as a result of dosing errors, and are taken to emergency rooms due to errors in medication dosage.

There is a need to facilitate proper pharmaceutical dosage. A simple, inexpensive, consumer friendly device that improves dosing accuracy and ease would be welcomed by the public, and should reduce medical complications resulting from errors in dosing.

### SUMMARY OF THE INVENTION

The invention includes a measuring and diluting cup for preparing pharmaceutical doses. The cup comprises an upstanding body having an open mouth and a hollow interior bounded by a sidewall. The cup also has a pharmaceutical measuring compartment. The pharmaceutical measuring compartment is opposite the open mouth and forms a bottom of the hollow interior. The cup also has a diluent measuring compartment which is adjacent the open mouth. The pharmaceutical measuring compartment captures a measured volume smaller than the volume of the diluent measuring compartment, and the pharmaceutical measuring compartment opens to the diluent measuring compartment. The upstanding body is substantially cylindrical and the pharmaceutical measuring compartment has a cylindrical or conical region concentric with the upstanding body. The pharmaceutical measuring compartment has a smaller diameter than the upstanding body.

### BRIEF DESCRIPTION OF THE DRAWINGS

FIG. 1 is a schematic representation of a substantially cylindrical pharmaceutical dosage cup with a pharmaceutical measuring compartment containing concentric cylindrical regions according to one embodiment of the invention.

FIG. 2 is a schematic representation of a top view of a pharmaceutical dosage cup with a pharmaceutical measuring compartment containing concentric cylindrical regions according to one embodiment of the invention.

FIG. 3 is a schematic representation of a conical pharmaceutical dosage cup with a pharmaceutical measuring compartment containing concentric cylindrical regions according to one embodiment of the invention.

FIG. 4 is a schematic representation of a kit comprising a bottle and a pharmaceutical dosage cup according to one embodiment of the invention.

FIG. 5 is a schematic representation of a pharmaceutical dosage cup with measured volume indicia according to one embodiment of the invention.

### DETAILED DESCRIPTION OF THE INVENTION

The invention includes a pharmaceutical dosage cup designed to allow individual users to measure smaller volume amounts in the bottom region of the cup, and larger volume amounts in the upper portion of the cup. The invention is designed to allow individuals to measure a smaller amount of a concentrated pharmaceutical solution in the bottom of the cup, and dilute that measured volume with a diluent volume measured in the same cup using the upper portion of the cup.

In one embodiment, the bottom of the cup has a step-like series of concentric cylinders of varying diameters that are calibrated and marked to deliver pre-determined volumes. The upper portion of the dosage cup has a larger, more uniform diameter which is suitable for receiving and measuring diluents. In using the cup, the user is able to dilute the measured pharmaceutical dose to an appropriate concentration.

In another embodiment, the cup has a lid which seals the cup, permitting the user to mix the pharmaceutical and diluent(s) in the cup without spilling the solution.

The smaller area at the base of the cup permits small volume measurements. The small volume measurement area at the base is combined with a larger volume area at the open end of the cup which accommodates larger volumes appropriate for diluents.

The step-wise increase of concentric cylinders at the base, as well as other embodiments, such as a conical shaped base, provide visual clarity in measuring smaller volume amounts. For example, the smallest cylindrical region can be adapted to measure approximately 1 ml. The measurement of such a relatively small amount is facilitated by the separation between the cylindrical regions of different diameters. It is contemplated that the smallest cylindrical region can be adapted to contain as little as approximately 0.25 ml (¼ tsp), whereas the entire diluting cup can be adapted to contain as much as approximately 120 ml (4 oz) of liquid. In a preferred embodiment, the diluting cup is adapted to contain 60 ml (2 oz) of liquid.

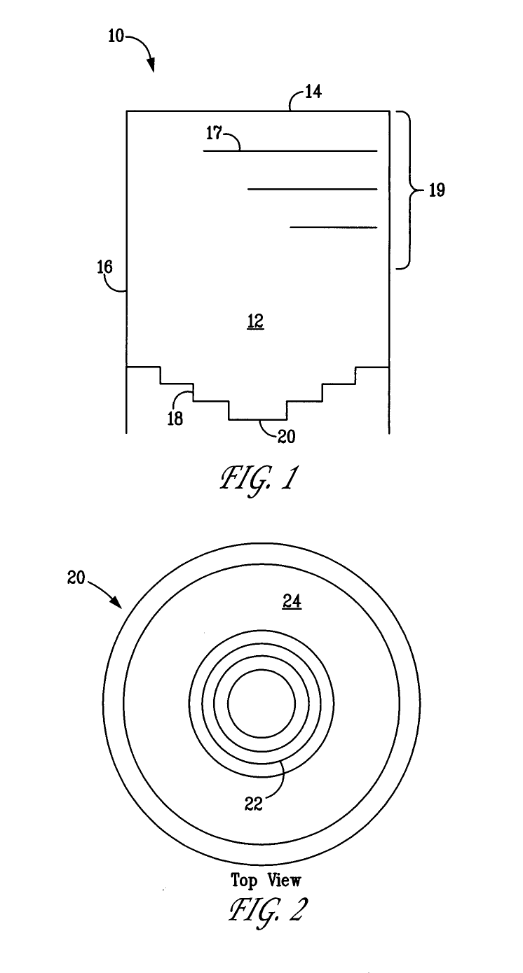

Referring to FIG. 1, a measuring and diluting cup 10 for preparing pharmaceutical doses is shown having an upstanding body 12 with an open mouth 14 and a hollow interior bounded by a sidewall 16. The cup has a pharmaceutical measuring compartment 18 opposite the open mouth which forms the bottom of the hollow interior of the cup. The cup also has a diluent measuring compartment 19 which is adjacent the open mouth. Alternatively, the diluent measuring compartment is referred to as the upper portion of the cup or the top portion of the cup, whereas the pharmaceutical measuring compartment is alternatively referred to as the lower portion or the bottom portion of the cup.

The pharmaceutical measuring compartment 18 captures a measured volume smaller than the volume of the diluent measuring compartment 19. The pharmaceutical measuring compartment opens to the diluent measuring compartment such that liquid solutions freely mix between the two compartments. The upstanding body 12 is substantially cylindrical and the pharmaceutical measuring compartment comprises a cylindrical region 20 concentric with the upstanding body. The pharmaceutical measuring compartment has a smaller diameter than the upstanding body.

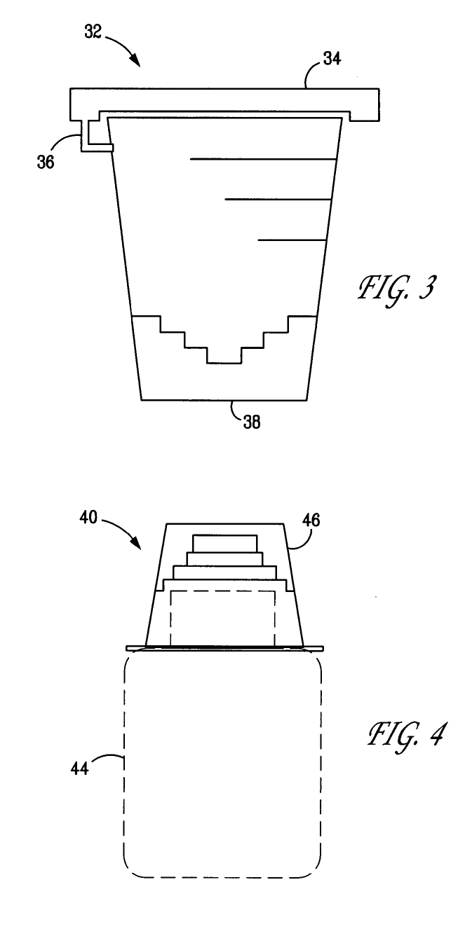

As shown in FIG. 1, the pharmaceutical measuring compartment is concentric with the open mouth, and has a series of cylindrical regions concentric with the upstanding body. The concentric cylindrical regions each capture sequentially smaller measured volumes as their diameters decrease. A top view of this cup is shown in FIG. 2, where the sequentially smaller cylindrical regions are shown as rings 22 in the center of the open mouth 24.

A measured volume in the pharmaceutical measuring compartment is delineated by the transition to the adjacent region with a different diameter. The measured volume in the diluent measuring compartment is delineated by indicia indicating a volume amount. Indicia 17 such as a line, grove, color tint, or other appropriate mark can indicate the fluid level corresponding to the measured volume amount. The measured volume amount can also be indicated as a label to the fluid level indicia. Indicia indicating volume amounts can also be used in the pharmaceutical measuring compartment. Such indicia can be positioned to coincide with the appropriate cylindrical region of the specified volume amount. An example of these described indicia is detailed in Example 1 below with reference to FIG. 5.

It is clearly contemplated that the desired volume of pharmaceutical may fill less than the entire pharmaceutical measuring compartment. For instance, the required dosage of pharmaceutical may only fill one measured volume within the entire pharmaceutical measuring compartment. In such a case, when diluent is added, diluent will first enter the pharmaceutical measuring compartment and the pharmaceutical measuring compartment will fill completely with diluent/pharmaceutical mix until the mix enters the diluent measuring compartment and reaches the appropriate fluid level indicated by the diluent measuring compartment.

Another embodiment of the invention includes a lid that interfaces with the open mouth of the cup and closes the hollow interior opposite its bottom. Referring to FIG. 3, a conical shaped cup 32 is shown with a lid 34 secured to the interior sidewall surrounding the open mouth. Optionally, the lid can be attached to the upstanding body of the cup by a tether 36. The lid can be in the form of a snap-cap that can be repeatedly secured and released. With the lid secured to the top of the cup, the pharmaceutical and diluent can be mixed by inverting the cup.

Concerning the base or bottom of the cup, the sidewall of the cup can extend from the open mouth beyond the bottom of the hollow interior, as shown in FIG. 3. Alternatively, the sidewall of the cup can extend to be approximately coplanar with the bottom of the hollow interior, as shown in FIG. 1, with the bottom of the pharmaceutical measuring compartment functioning as part of the base of the cup along with the sidewall. In this arrangement, the sidewall extends evenly with the bottom of the hollow interior. In either configuration, the bottom of the cup can be open, as shown in FIG. 1, with the cup being stabilized by the sidewall, or the bottom of the cup can be sealed with a flat bottom 38, as shown in FIG. 3. A further embodiment is contemplated wherein the sidewall is angled inwardly from the open mouth to the bottom as shown in FIG. 3.

In one embodiment, the measuring cup is designed so that the pharmaceutical measuring compartment and the diluent measuring compartment are proportional in volume. The proportion is such that a measured volume captured in the pharmaceutical measuring compartment dilutes to an appropriate dosage concentration when diluted in a measured volume of diluent contained in the diluent measuring compartment. One example of proportional volumes is set forth in Example 1. Essentially, the cup proportions can be determined so that the pharmaceutical measuring compartment captures a predetermined dose of pharmaceutical, such as 50 mg of active ingredient. The accompanying diluent measuring compartment provides a fluid volume that combines to form an oral solution tolerable or agreeable for administration to the patient. Additionally, the cup can be designed and labeled to prepare multiple doses at a single concentration.

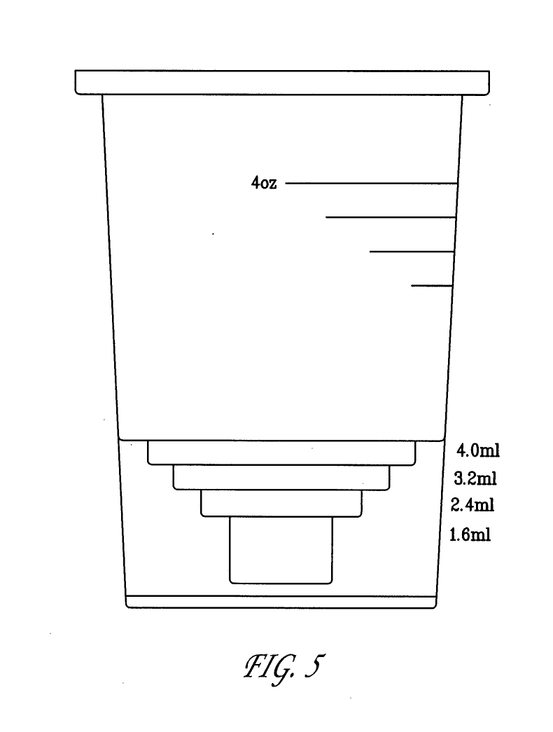

In another embodiment of the invention, a pharmaceutical dosage kit 40 comprising a bottle and a measuring and diluting cup is provided. With reference to FIG. 4, packaging for a pharmaceutical can include a solution bottle 44 with an accompanying measuring and dosage cup 46 as described herein. In this case, the measuring and dosage cup volumes and indicia can be tailored to coincide with the dosage instructions provided on the pharmaceutical battle label.

Although not shown, the measuring and diluting cup may include a series of sequentially smaller measured volumes which are defined by concentric conical sections of decreasing diameter. In this configuration, the pharmaceutical measuring compartment comprises conical sidewalls rather than cylindrical, as shown in the figures.

### EXAMPLES

### Example 1

In this example, a pharmaceutical solution with a concentration of 25 mg active ingredient/ml is provided. The dosage cup accompanying the bottle would have a pharmaceutical measuring compartment with a first cylindrical region with a small diameter that captures approximately 1.6 ml. The pharmaceutical measuring compartment would have a second cylindrical region with a slightly larger diameter that captures another 0.8 ml to hold a total of 2.4 ml, a third cylindrical region with an even larger diameter region capturing an additional 0.8 ml to hold a total of 3.2 ml, and then a fourth cylindrical region of still larger diameter that captures another 0.8 ml for a total volume within the pharmaceutical measuring compartment of 4.0 ml.

With a concentrated solution of 25 mg/ml as the pharmaceutical solution, 1.6 ml of the solution provides a 40 mg dose of pharmaceutical, 2.4 ml of solution provides a 60 mg dose, 3.2 ml provides a 80 mg dose, and 4.0 ml of solution provides a 100 mg dose. All of these dose amounts can be diluted up to approximately 4 ounces for oral administration.

The upper portion of this cup is the diluent measuring portion and has a still larger diameter, marked with indicia indicating total fluid ounces contained in the cup, with an upper indicator indicating a level measuring 4 fluid ounces. A schematic of a cup in accordance with this example is shown in FIG. 5.

### Example 2

This example is specific to a known liquid pharmaceutical preparation known as CEP-701 (manufactured by Cephalon, Inc.). An appropriate dosage for CEP-701 is typically diluted in 1 ounce, and in particular, the dosage of CEP-701 is approximately 0.8 ml. As such, a dosage cup can be used that is identical to that disclosed in Example 1, except that it should include an initial increment of 0.8 ml as the smallest diameter.

### Example 3

Typical liquid pharmaceutical formulations are designed to be 1 teaspoon (5 ml). An appropriate dosage cup for such a typical 1 teaspoon formulation would have dosage volumes as follows: 1.25 ml (¼ tsp), 2.5 ml (½ tsp), 3.75 ml (¾ tsp) and 5 ml (1 tsp).

### Example 4

In the case of very large dosage liquid formulations, a larger cup is designed that is adapted to the higher dosing ranges. Specifically, the dosages, in incremental order would be as follows: 2.5 ml (½ tsp), 5 ml (1 tsp), 15 ml (3 tsp, 1 TBSP), and 30 ml (6 tsp or 1 oz.).

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A measuring and diluting cup for preparing pharmaceutical doses comprising:
(a) an upstanding body having an open mouth and a hollow interior bounded by at least one sidewall;
(b) a pharmaceutical measuring compartment, wherein the pharmaceutical measuring compartment is opposite the open mouth, forming a bottom of the hollow interior;
(C) a diluent measuring compartment, wherein the diluent measuring compartment is adjacent the open mouth;
wherein the pharmaceutical measuring compartment captures a measured volume smaller than the volume of the diluent measuring compartment, and wherein the pharmaceutical measuring compartment opens to the diluent measuring compartment, and wherein the upstanding body is substantially cylindrical and the pharmaceutical measuring compartment comprises a cylindrical or conical region concentric with the upstanding body, the pharmaceutical measuring compartment having a smaller diameter than the upstanding body.

2. The measuring and diluting cup of claim 1 wherein the pharmaceutical measuring compartment is concentric with the open mouth, and comprises a series of cylindrical or conical regions concentric with the upstanding body, the regions capturing sequentially smaller measured volumes.

3. The measuring and diluting cup of claim 2 wherein the series of sequentially smaller measured volumes are defined by concentric cylinders of decreasing diameter.

4. The measuring and diluting cup of claim 2 wherein the series of sequentially smaller measured volumes are defined by concentric conical sections of decreasing diameter.

5. The measuring and diluting cup of claim 1 wherein the diluent measuring compartment comprises an indicator indicating a volume amount.

6. The measuring and diluting cup of claim 1 wherein the pharmaceutical measuring compartment comprises an indicator indicating a volume amount.

7. The measuring and diluting cup of claim 1 further comprising a lid that interfaces with the open mouth and closes the hollow interior opposite its bottom.

8. The measuring and diluting cup of claim 7 wherein the lid is tethered to the cup.

9. The measuring and diluting cup of claim 1 wherein the sidewalls extend from the open mouth beyond the bottom of the hollow interior.

10. The measuring and diluting cup of claim 1 wherein the sidewalls extend from the open mouth evenly with the bottom of the hollow interior.

11. The measuring cup of claim 1 wherein the pharmaceutical measuring compartment comprises a size adapted to capture approximately 0.25 ml of pharmaceutical solution.

12. The measuring cup of claim 1 wherein the measuring cup comprises a size adapted to capture approximately 120 ml of solution.

13. The measuring cup of claim 1 wherein the pharmaceutical measuring compartment and the diluent measuring compartment are proportional in volume such that a measured volume captured in the pharmaceutical measuring compartment dilutes to an appropriate dosage concentration when diluted in a measured volume of diluent contained in the diluent measuring compartment.

14. A measuring and diluting cup for preparing pharmaceutical doses comprising:
(a) an upstanding body having an open mouth and a hollow interior bounded by a sidewall;
(b) a pharmaceutical measuring compartment, wherein the pharmaceutical measuring compartment is opposite the open mouth, forming a bottom of the hollow interior;
(C) a diluent measuring compartment, wherein the diluent measuring compartment is adjacent the open mouth;
wherein the pharmaceutical measuring compartment captures a measured volume smaller than the volume of the diluent measuring compartment, and wherein the pharmaceutical measuring compartment opens to the diluent measuring compartment;
wherein the upstanding body is substantially cylindrical and the pharmaceutical measuring compartment is concentric with the open mouth and comprises a series of concentric cylindrical or conical regions, the regions capturing sequentially smaller measured volumes of 4.0 ml, 3.2 ml, 2.4 ml, 1.6 ml, 0.8 ml the sequentially smaller measured volume regions having sequentially smaller diameters than the open mouth;
wherein the diluent measuring compartment comprises an indicator indicating a volume of 4 oz for the combined volume of the diluent measuring compartment and the pharmaceutical measuring compartment.

15. A pharmaceutical dosage kit comprising a bottle and the measuring cup of claim 14.

16. A pharmaceutical dosage kit comprising a bottle and the measuring cup of claim 1.
